(19) United States
(12) Patent Application Publication
(10) Pub. No.: US 2026/0186761 A1
(43) Pub. Date: Jul. 2, 2026

(54) CUSTOMER-MANAGED CLOUD COMPUTING SOLUTIONS

(71) Applicant: MicroStrategy Incorporated, Vienna, VA (US)

(72) Inventors: Jay Indravadan Shah, Aldie, VA (US); Clayton Myers, Oak Hill, VA (US); Shreyas Shah, Vienna, VA (US); Jae Wu Berlik, Round Hill, VA (US)

(21) Appl. No.: 19/004,971

(22) Filed: Dec. 30, 2024

(51) Int. Cl. G06F 8/65; G06F 8/61; G06F 9/54

(52) U.S. Cl. CPC G06F 8/65; G06F 8/63; G06F 9/54

(57) ABSTRACT

Methods, systems, and apparatus, including computer programs encoded on computer-storage media, for managing software in cloud computing platforms and other server systems. In some implementations, a system obtains a set of software modules from a repository of a software provider. Based on the set of software modules, an application programming interface (API) gateway and a cluster operator module are installed in a management namespace of a cluster of processing nodes. One or more applications are installed in an environment namespace. The system maintains a set of custom resources outside the environment namespace, wherein the custom resources provide customizations that are applied to the one or more applications in the environment namespace. Software in the management namespace is configured to apply the customizations after software of the one or more applications in the environment namespace is updated.

### BACKGROUND

The present specification relates to management of cloud computing functionality, such as cloud-based server environments and cloud-based applications.

As capabilities of networks and data centers have improved, more and more organizations have taken advantage of cloud computing platforms to host applications. Cloud computing can provide significant advantages in versatility and flexibility for running applications and serving content to client devices. Nevertheless, deploying and managing applications and server environments can be challenging for many organizations.

### SUMMARY

In some implementations, a computer system provides functionality that enables administrators to deploy and manage software in cloud-computing platforms, on-premises servers, and other platforms. In the system, a software provider can provide multiple options for managing application deployment, such as management by the software provider or management by the customer. To enable the customer to manage software deployments, the software provider can provide management tools that the customer can run to create and manage computing environments and application deployments, while still retaining the ability to customize the configuration of the application and set customized policies. The management tools can be configured to enable updates to applications (e.g., updated versions, software patches, etc.) from the software provider to be made while still maintaining the customer's customizations. In addition, the local management tools for customer-managed software deployments can support application programming interfaces (APIs) similar to those of the software provider's own remote management tools, so that application deployments can be coordinated across a variety of different platforms and management approaches (e.g., cloud-based or on-premises, and software-provider-managed or customer-managed).

Many companies benefit from systems where a software provider can manage application deployment on their behalf. In many cases, this enables the software provider to update applications, monitor and improve performance, adjust configuration settings, and so on. However, other companies desire greater control over their systems and do not want to rely on management tools run by another party, even if it is the provider of the software. For example, some companies in regulated industries desire high levels of control over their system configuration to protect sensitive data and ensure regulatory compliance and security requirements. These companies may need to add or alter various policies and controls in customized ways, without another party having access to configuration settings. In many cases, requirements for data protection and role-based access to ensure continuous compliance may not be compatible with management through a software provider's network-based management tools. As a result, it is desirable for many companies to host applications in the company's own controlled environments so that their unified compliance and security policies and controls can be applied.

When software is deployed to customer-controlled infrastructure, the software provider generally does not have the ability to manage the deployment process to adjust settings, monitor performance, and so on. In addition, the software provider is generally not aware of the customizations and settings that are used in the customer-controlled system. From time to time, the software provider will typically provide updates for applications, such as to improve security or add application features. With different customers using different configurations and infrastructure, however, there is a significant risk that the software updates will remove (e.g., overwrite) or otherwise alter those customizations. To enable software updates and retain customizations, the software provider can provide management tools that run on the customer-controlled infrastructure and that are configured to store custom resources separate from the applications. For example, custom resources that specify customizations can be stored in a management area or outside the environment namespace for the applications. The local management tools can be configured to obtain and apply software updates from the software provider, and then apply the customizations from the custom resources to the updated software. As a result, customizations by the customer can be maintained (e.g., restored or re-applied) even after software updates are made.

One of the advantages of the system is the ability of the deployment tools to integrate with other third-party solutions. For example, independent software vendors (ISVs) may integrate software from the software provider into their own offerings to address specific industries or business use cases. ISVs often need flexibility to customize applications, even at a component level, to create new integrated offerings that are provided to companies or other customers. The system provides versatility for ISVs and others to deploy a software provider's applications, with or without customizations, in a wide variety of accounts and platforms. The system is also useful to manage deployments in a customer-controlled infrastructure, whether in cloud computing platforms or on-premises hardware. The system enables enterprises with heightened security and compliance requirements to better manage data locality requirements and other security controls.

In some implementations, a method performed by one or more computers includes: obtaining, over a communication network, a set of software modules from a repository of a software provider; based on the set of software modules, installing an application programming interface (API) gateway and a cluster operator module in a management namespace of a cluster or processing nodes; using the cluster operator module to generate an environment namespace and install one or more applications in the environment namespace, wherein the one or more applications are obtained over the communication network from the repository of the software provider; and maintaining a set of custom resources outside the environment namespace, wherein the custom resources provide customizations that are applied to the one or more applications in the environment namespace, and wherein software in the management namespace is configured to apply the customizations provided by the set of custom resources after software of the one or more applications in the environment namespace is updated.

In some implementations, obtaining the set of software modules comprises obtaining one or more container images for the cluster operator module from the repository of the software provider; and the one or more applications are obtained in one or more container images from the repository of the software provider.

In some implementations, the cluster is a Kubernetes cluster, and the cluster operator is a custom Kubernetes operator.

In some implementations, the cluster operator module is configured to obtain updates to the one or more applications from the software provider over the communication network, apply the updates to the one or more applications in the environment namespace, and apply the customizations from the set of custom resources to the one or more applications after applying the updates to the one or more applications.

In some implementations, the set of custom resources is associated with the management namespace.

In some implementations, the customizations comprise one or more of a change to a hostname, an update to a cluster management policy, or adding support for a third-party software agent.

In some implementations, the method includes installing software in the management namespace that is configured to provide telemetry data to the software provider over the communication network, wherein the telemetry data comprises an amount of deployments or environments I the cluster, a software version for software in the cluster, license information for software in the cluster, usage data for software in the cluster, or status of services in the cluster.

In some implementations, the API gateway is configured to enable an administrator to adjust a configuration of the cluster and the one or more applications through communication with the API gateway, including setting policies for data ingress and egress for the one or more applications.

In some implementations, the API gateway implements in the cluster a same set of API gateway functions implemented by a server of the software provider for clusters managed through interaction with the server of the software provider, such that configuration changes made through API requests to the server of the software provider can be replicated through API requests to the API gateway.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for deploying and managing software.

FIG. 2 is a diagram showing an example of a deployment of software for a customer-managed account or infrastructure.

FIG. 3 is a diagram showing an example of applying customizations to a software deployment.

FIG. 4 is a diagram showing examples of modules and a split of responsibility among a software provider and a customer.

FIG. 5 is diagram showing an example of two different software deployments, one deployment managed through a software provider's system and another deployment managed by the customer using local management tools from the software provider.

Like reference numbers and designations in the various drawings indicate like elements.

### DETAILED DESCRIPTION

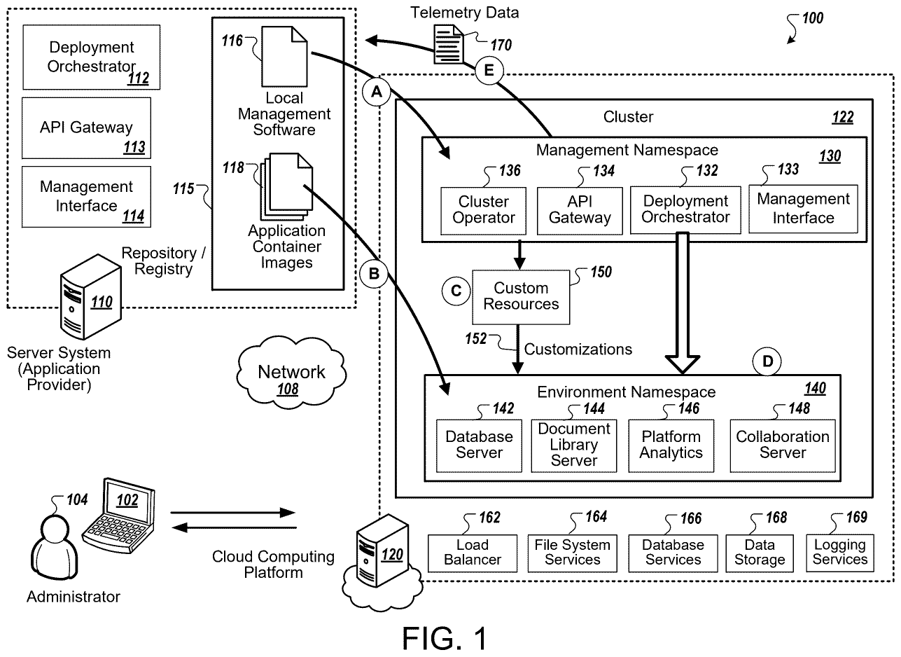

FIG. 1 is a diagram showing an example of a system 100 for deploying and managing software. The system 100 includes a server system 110 of an application provider, a cloud computing platform 120, a user device 102 of an administrator 104, and a communication network 108. The system 110 includes features that enable the applications from the application provider to be installed and run on a variety of different platforms, whether on-premises or on cloud-computing platforms, as well as managed remotely through the server system 110 or managed locally by the customer. The example of FIG. 1 shows an example of deploying applications to customer-managed infrastructure, with various actions and data flow shown through a series of stages labelled (A) through (E), which may be performed in the order shown or in another order.

Many enterprise applications require various infrastructure capabilities to provide content and services to client devices at a large scale. These include processing clusters, load balancers, filesystems and data storage services, database services, and so on. Traditionally, many deployment tools coupled the allocation or deployment of applications with the supporting infrastructure, so that an application provider's deployment tool would allocate or secure the various resources, services, and other infrastructure that the application needed to run. This allowed the deployment process to be controlled and managed by the application provider, which helped ensure compatibility and reduced the amount of configuration that customers would need to perform.

However, coupling the deployment of infrastructure and applications together limits the customization that customers can perform, and in many cases requires more access to a customer's account than the customer permits. The standardization of the deployment managed by the application provider improves ease of use for some customers, but it provides unacceptable restrictions on application customization and data security risks for other customers.

As discussed below, the system 100 enables software deployment that decouples infrastructure provisioning and application deployment, so customers can more easily deploy applications to their own infrastructure and have greater control over the system configuration and application behavior. For example, the system 100 allows customers to make customizations to their applications and infrastructure that would not possible if the software provider managed the deployment. In addition, the system 100 is arranged so that the customer-managed application can still receive updates to the application from the application provider, and customizations made by the customer are retained after the updates are made. These capabilities are particularly helpful for customers in regulated industries, where there is a need for customized data privacy and data access policies, and also for customers that are ISVs that provide the application provider's applications as part of an integrated solution that may incorporate software from various different sources. Regardless of the use case, the server system 110 provides deployment tools that can facilitate deploying applications to a cloud computing platform, on-premises server system, or other computing platform in a way that provides the ease-of-use of software-provider-managed deployments with the added customizability, control, and local management.

Referring to FIG. 1, the network 108 can include public or private networks and can include the Internet. The network 108 can include wired networks, wireless networks, local area networks, wide area networks, and more.

The server system 110 is operated by the application provider, which provides various applications that can be run on servers to support clients for a customer of the application provider. The server system 110 includes modules and features to deploy the applications on infrastructure provided by or managed by a customer. The server system 110 also includes modules and features to deploy the applications on infrastructure that the application provider provides or manages. This gives the customer versatility to choose which management approach is appropriate for each computing environment or deployment.

The server system 110 includes a deployment orchestrator 112 that manages the process of making new deployments, along with corresponding infrastructure, for deployments carried out by the application provider on behalf of customers. The server system 110 also includes a management interface 114 that provides an interface (e.g., web application, web page, etc.) through which a customer's administrators can change settings and obtain status information for deployments made by the application provider. The server system 110 also includes an API gateway 113, which provides an interface for requests to be made to the server system 110 and for responses to be provided.

The server system 110 also includes features that enable customers to deploy the applications to their own infrastructure, along with management tools that will reside in the customer's account or infrastructure. This enables the customer to make customizations and configuration changes to deployments directly, e.g., without the need to route requests through the API gateway 113 and management interface 114 of the server system 110. For example, the server system 110 can store local management software 116 that can be downloaded to an installed on a customer's own server or to a cloud computing account of the customer, which will provide the management tools locally in the customer's account rather than through the application provider's server system 110. As discussed further below, the local management software 116 provides the ability for customer-managed deployments of the applications to be updated over time with updates from the application provider, while still retaining customizations (e.g., configuration changes) made to the applications and related infrastructure that are not known to the application provider.

The server system 110 also stores a registry or repository 115 of software modules for the applications that the application provider provides. For example, the registry or repository 115 can include container images (e.g., software images that can be run as containers) for one or more applications.

The cloud computing platform 120 is a server system that can be provided by a third party. In the example of FIG. 1, the customer (e.g., an enterprise) has an account in the cloud computing platform 120. An administrator 104 for the customer sets up a cluster 122 of processing nodes in the cloud computing platform 120 and also arranges for various resources and services to be provided. For example, a set of pre-requisite services may be required to install and use the applications from the application provider. In the example, various infrastructure components are provided outside the cluster 122, such as a load balancer 162, file system services 164, database services 166, data storage 168, and logging services 169. The administrator 104, through the user device 102, can arrange for the cluster 122 and related infrastructure to be provisioned and made ready for installation of the applications from the application provider.

To begin deployment, in stage (A), the administrator 104 requests to begin the deployment process, and local management tools are installed in the cluster 122. For example, the administrator 104 can cause a request to be sent to the API gateway 113 for the local management software 116 to be transferred to and installed on the cluster 122. The request can be sent to the server system 110 from the customer account in the cloud computing platform 120, or can be sent from the user device 102 with information identifying the cloud computing platform 120 and the customer account. The administrator 104 can first authenticate with the server system 110, and after verifying the credentials and access permissions, the server system 110 can provide the local management software 116 to be installed.

In the cluster 122 on the cloud computing platform 120, the local management software 116 is installed to provide various modules in a management namespace 130. These modules can include, for example, a deployment orchestrator 132, a management interface 133, an API gateway 134, and a cluster operator 136. These modules are listed as examples to illustrate various functions of the management tools, but the modules and their functions can be alternatively be provided in more or fewer modules than are illustrated. For example, the features of multiple of these modules may be provided in a single module.

The deployment orchestrator 132 provides features to perform the deployment of applications in the cluster 122. The deployment orchestrator 132 can act as a local agent running on the cluster 122 to establish connections with the server system 110, authenticate a user, and then provide information about a destination for transferring application modules for deployment. The deployment orchestrator 132 can then perform actions to establish computing environments and deploy applications as discussed below.

The API gateway 134 provides an interface to send and receive messages and data for managing the cluster 122 and applications deployed on it. The management interface 133 provides an interface for the administrator to make configuration changes and view the status of applications and environments on the cluster 122. Together, the API gateway 134 and the management interface 133 provide the functionality for the administrator 104 to manage applications from the application provider without having to route requests to (or otherwise rely on) the server system 110 for management. In many cases, some or all of the management functions and APIs that are supported by the API gateway 113 and management interface 114 are supported by the API gateway 134 and the management interface 133.

The cluster operator 136 provides module that can automate steps for deployment and management. For example, the cluster operator 136 can provide a framework in which the administrator 104 can specify code and use a predefined workflow. The cluster operator 136 can also be configured to respond to different situations, so that the state changes or certain conditions are detected (e.g., when predetermined criteria are satisfied), corresponding actions, code, or workflows are executed. The cluster 122 can be a Kubernetes cluster, and the cluster operator 136 can be a custom Kubernetes operator. The cluster operator 136 can include scripts or other code to automate various different processes, such as deploying software, upgrading software, scaling up or down, backup, restore, starting and stopping services, and so on. In some implementations, the functionality of the deployment orchestrator 132 can be implemented as code or workflows performed by the cluster operator 136 when deployment of an application is requested.

In general, the cluster operator 136 can store different code or workflows to perform for different situations. The cluster operator 136 can communicate with the API gateway 134 and management interface 133, so that various different types of management requests or actions each trigger the appropriate workflow or series of management actions.

In stage (B), applications are deployed in the cluster 122 based on the container images 118 in the registry or repository 115. After the various management tool components are installed in the management namespace 130, the deployment of applications can proceed.

In some implementations, the administrator initiates the deployment by sending a request through the API gateway 134 for applications or environments to be deployed, and this request initiates the creation of an appropriate computing environment and/r namespace, in addition to the applications. For example, the deployment orchestrator 132 creates an environment namespace 140 that is separate from the management namespace 130. The environment namespace 140 can correspond to a computing environment, running on the cluster 122, in which instances of the applications will be deployed.

The applications are installed based on the application container images 118 from the registry or repository 115. In some implementations, as part of the deployment process, the deployment orchestrator 132 or other local management tools request and receive the container images 118 over the network 108 as needed for the deployment. In other implementations, the management tools can download a local copy of the registry or repository 115, as part of stage (A) or later. As a result, all the containers 118, documentation, and other data from the registry or repository 115 can be copied into the customer account in the cloud computing platform 120. The applications can then be installed from the local copy of the registry or repository 115 made in the account in the cloud computing platform 120.

In the example, container images 118 for various applications are installed, including for a database server 142, a document library server 144, platform analytics 146, and a collaboration server 148. The application containers can then be started to run the applications.

In stage (C), the administrator 104 makes customizations to the applications and/or the computing environment for the applications. For example, the cluster 122 can have a set of custom resources 150 for the environment in which the applications run. The custom resources 150 can include, for example, files, settings, configuration data, and so on. These custom resources 150 are stored outside the environment namespace 140 and are managed by the cluster operator 150 or other tools. The management interface 133 and the API gateway 134 can provide access for the administrator 104 to add, remove, or alter the custom resources 150.

The custom resources 150 can be used to make customizations 152 to the applications in the environment name space 140. For example, the cluster operator 136 can be configured to use the custom resources 150 to make the customizations 152 to alter the applications as specified by the container images 118 from the application provider. These customizations 152 can include configuration changes such as updating hostnames, updating network addresses, updating cluster policies (e.g., Kubernetes policies), adding third-party agents, and more. Other customizations can include additional data access policies security policies, authentication policies, and so on. The cluster operator 136 can be configured to detect or be notified about changes to the custom resources, and to trigger application of a changed set of customizations when the custom resources 150 change.

In stage (D), the applications are run and access can be provided to client devices of users. After the management tools are installed in the management namespace 130 (stage (A)), a computing environment and applications are created in the environment namespace 140 (stage (B)), and the desired customizations 152 are applied (stage (C)), the applications are ready to interact with users over the network 108.

Over time, updates to the applications are often needed. These updates may be upgrades to a new version of the applications, updates to add functionality or improve interoperability, patches to improve security, or other updates. The cluster operator 136 can be configured to request information about updates periodically, or an administrator may request through the management interface 133 for updates to be downloaded and applied. As another example, the server system 110 may inform the cluster operator 136 when updates become available. In each case, the cluster operator 136 downloads the updates over the network 108 and applies the updates to the applications.

In many cases, updates from the server system 110 may alter or overwrite the customizations 152 that are applied to the applications. After all, the software provider does not manage the cluster 122 and typically does not have visibility about which customizations 152, if any, have been applied. Software updates are typically focused on a particular configuration or set of configurations which may be different from the customized configuration that the administrator 104 has specified. As a result, the updates from the application provider, which describe or intended for a standardized configuration, may remove or alter the custom settings and custom code or content that has been applied.

To provide the customizations even after a software update, the cluster operator 136 can be configured to re-apply the customizations 152 after software updates are made. The workflows for applying software updates to applications can include reapplying the appropriate customizations 152 based on the custom resources 150. Because the custom resources 150 are stored outside the environment namespace 140, the custom resources 150 are retained and are unaffected by software updates for the applications and other data in the environment namespace 140, and so the customizations 152 can be applied again to preserve the custom configuration of the applications. This arrangement enables software deployments to benefit from customer control and customized policies, while retaining the ability to receive application updates for the applications.

The server system 110 can provide updates for the management tools (e.g., the cluster operator 136, the API gateway 134, the deployment orchestrator 132, the management interface 133, etc.) also. The cluster operator 136 can cause these management tools to be updated also when updates become available.

In stage (E), the management tools 130 can provide telemetry data 170 to the server system 110 over the network 108. The cluster 122 and applications are managed locally by the customer, but sending some information about the deployment can enable the application provider to verify proper operation and provide recommendations for improvements. For example, the cluster operator 136 can be configured to periodically send telemetry data 170 indicating a number of deployments, the types of applications and versions of the applications (e.g., version numbers), license information, and so on. The sending of telemetry data 170 can be an automated process that sends the data to a predetermined network address or URL for the server system 110 to receive.

Based on the information in the telemetry data 170, the server system 110 can generate information to improve the function and performance of the applications. For example, based on error messages or other status information sent in the telemetry data 170, the server system 110 can identify configuration changes to make (e.g., resize, re-scale, scale up, scale down, update an application, etc.). The server system 110 can then send information identifying the configuration changes to make, which can be indicated to the administrator 104 and after approval by the administrator 104 can be carried out by the cluster operator 136. In some cases, configuration changes specified by the server system 110 can be applied automatically to improve the operation of the applications.

In the example the applications are deployed to customer-controlled infrastructure in the cloud computing platform 120. However, the same techniques can be used to deploy applications to an on-premises account or other non-cloud-computing computer system.

In some implementations, the tools for deploying and managing applications through the server system (e.g., with application-provider-managed infrastructure) are significantly replicated in customer-managed infrastructure. For example, the deployment orchestrator 112, the API gateway 113, and management interface 114 can be mirrored or replicated in the management namespace 130 by the deployment orchestrator 132, the API gateway 134, and the management interface 133. Although the tools at the server system 110 and at the cluster 122 do not need to be exactly the same, they can nevertheless support a common set of API features (e.g., function calls, protocols, parameter types, request formats, etc.) for deploying and managing applications, so that requests and workflows that would be performed to deploy or manage applications through the server system 110 can also be used to deploy or manage applications through direct management by communication with the tools in the management namespace 122.

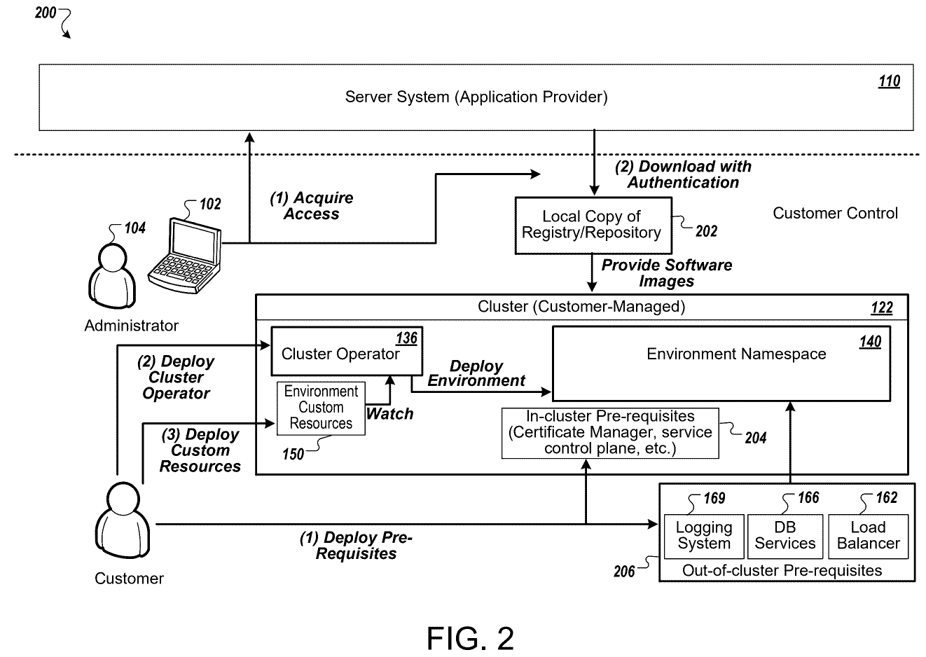

FIG. 2 is a diagram showing an example 200 of a deployment of software for a customer-managed account or infrastructure. The example shows another view of the process of deploying applications to customer-controlled infrastructure.

In the example the server system 110 provides the same features and modules as described in FIG. 1 The administrator 104 uses the user device 102 to acquire access to the server system 110, for example, by accessing the management interface 114 of the server system 110 and/or sending a request through the API gateway 113 of the server system 110. The administrator the proceeds to download the registry or repository 115 from the server system 110 into the customer-controlled system, which can be cloud-computing account, an on-premises server, or another system. This is shown as a local copy 202 of the registry or repository in customer storage, which can include the application container images 118 as well as the local management software 116 as well as other items (e.g., configuration settings files, drivers, third-party integration tools, etc.).

The process of deploying the software includes deploying the cluster operator 136 from based on the data in the local copy 202 of the registry or repository 115. Note that the cluster 122 is created and managed by the customer, but the custom operator 136 from the application provider brings the workflows, settings, conditional behavior, and so on so that environments and applications in the cluster are managed effectively and appropriately. The cluster operator 136 then runs to deploy a new environment, represented by the environment namespace 140, and applications are installed in the new environment, such as by transferring the appropriate container images and settings from the local copy 202 of the registry or repository 115 into the new environment.

The administrator 104 can then cause custom resources 150, including policies, settings, configuration changes, and so on, to be deployed to the cluster 122. The cluster operator 136 is configured to watch for changes to the set of custom resources 150 and to incorporate the custom resources, or the customizations they specify, into the deployed environment and applications. As a result, when the administrator provides a new custom resource or changes settings specified by those resources (e.g., changing a hostname, updating a cluster management policy, or adding support for a third-party software agent), the cluster operator 136 initiates the processes to automatically make the corresponding changes to the environment and applications in it.

The deployment tools can rely on a set of resources and services, both inside the cluster 122 and outside the cluster 122. These pre-requisites can be specified by the application provider and provided by the customer before the application deployment takes place. In some implementations, the software for installing the cluster operator 136 verifies the presence of the needed services and resources. As another example, the cluster operator 136 itself can verify that needed services and resources are present before deploying applications to the managed environments (e.g., in the environment namespace 140. If needed pre-requisite infrastructure elements are not present, the deployment process can be paused or aborted and the administrator is notified of the needed items.

The out-of-cluster pre-requisites include items such as the load balancer 162, the database services 166, the logging system 169, and others (e.g., filesystem services, data storage services, etc.). Other in-cluster pre-requisites 204 can be required and provided, such as a certificate manager, a service control plane, and others.

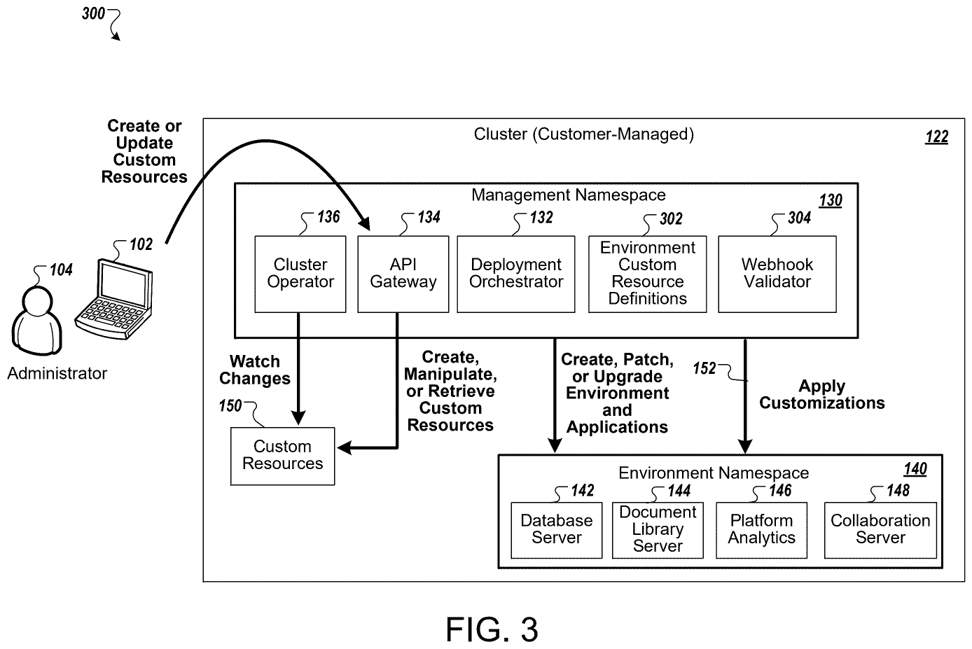

FIG. 3 is a diagram showing an example 300 of applying customizations to a software deployment. In the example, the administrator 104 has already created a customer-managed cluster 122, management tools have been installed in the management namespace 130, and applications have been deployed to the environment namespace for a computing environment managed using the management tools. FIG. 3 shows in additional detail the application of customizations to environments and applications.

As discussed above, the cluster operator 136 or deployment orchestrator 132 can maintain storage of custom resources 150. Storing customer resources 150 in this manner can provide a data persistence layer for a deployment, e.g., for one or more applications in an environment run on the cluster 122, or potentially for all applications or all environments that run on the cluster 122. The data is configured to persist not only when starting or stopping the applications or when turning on and off the environments, but also after software updates from the application provider (e.g., software upgrades, patches, etc.), even when the software updates change settings from custom settings or behavior to standardized or default settings and behavior. The cluster operator 136 is configured to apply customizations based on the custom resources 150 after each update, so that the customizations are maintained, e.g., re-applied or restored, even if they are changed during the software update process.

The API gateway 134 in the management namespace 130 of the cluster 122 enables the administrator 104 an interface to initiate changes to the custom resources 150, such as to create or update custom resources 150. The management interface 133 (see FIG. 1) can similarly provide interfaces for adjusting custom resources 150. As requested, the management tools can create, retrieve, alter, transfer or otherwise adjust the custom resources 150. The cluster operator 136 is configured to monitor for changes in the custom resources 150. When a change is detected, the cluster operator 136 applies the corresponding changes to the managed environments and applications. In addition, after changes to the managed environments or applications, such as creating, patching, or upgrading an environment or application, the cluster operator 136 also applies the customizations specified by the custom resources.

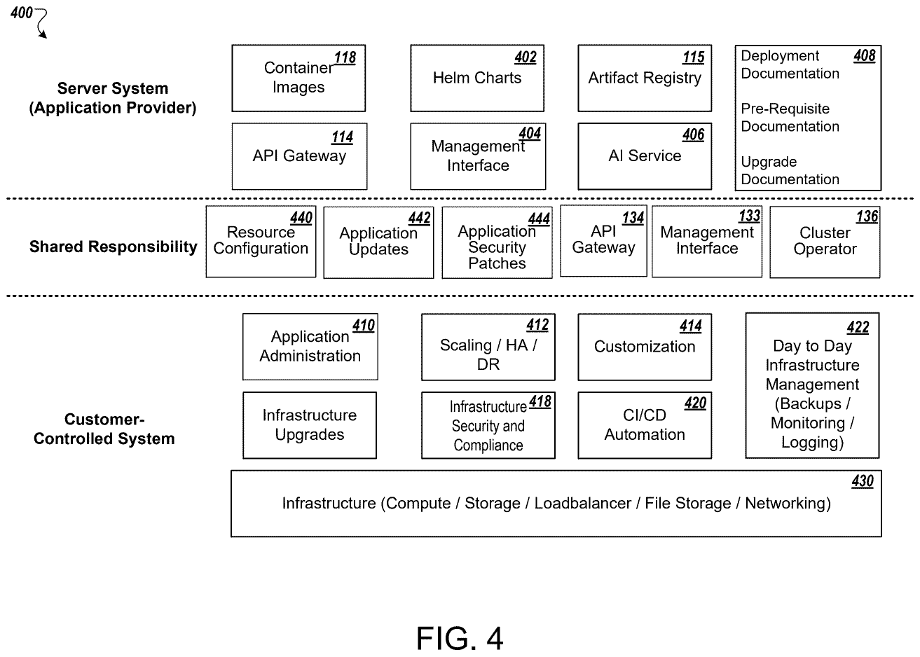

FIG. 4 is a diagram showing examples of modules and a split of responsibility among a software provider and a customer. The diagram shows items provided by and managed by the software provider, other items managed by the customer, and a set of items with shared responsibility.

The server system 110 provides the API gateway 113, the registry 115, and the container images 118, as well as Helm charts 402, a management interface 404, an AI service 406, and documentation 408. The API gateway 113 provides an interface for administrators to send requests to interact with the server system 110, including to obtain information from the software provider, such as the software modules to install local management tools and applications, software updates (e.g., upgrades, add-ons, security patches, etc.), and more. The software for the local management tools and the applications can be provided as container images 118 or in another format. The container images 118 and other items can be listed in and identified using the registry 115 or another repository. The server system 110 stores and provides Helm charts 402 that customers can retrieve and apply to manage their clusters.

The management interface 404 provides a interface (e.g., a web page, a web application, etc.) that enables administrators to manage environments and applications set up for remote management through the software provider's management tools. The API gateway 113 can also provide remote access, over a communication network, for administrator to manage computing environments and application deployments that are managed through the software provider's tools. By contrast, for customer-managed clusters and environments, the deployments are managed more directly through a local API gateway 134 (e.g., API layer) and a local management interface 133 or other management tools in the customer-managed cluster, without the need to communicate changes to or through the software provider's systems. The ability for customers to choose, for each deployment, whether to perform management through the software provider's server system 110 or through local customer management provides versatility. In some implementations, it enables a consistent set of API calls and management functions to be used to manage both customer-controlled and software-provider-managed clusters and environments, with each of the management interfaces 133, 404 supporting a common set of functions and each of the API gateways 134, 114 (e.g., API layers) supporting a common set of functions. This enables customers to choose for each deployment whether to deploy software with hosted management from the software provider, local management by the customer, and also to switch relatively easily among the options.

The server system 110 also provides an AI service 406 that can provide chatbots enabled by large language models (LLMs) and other artificial intelligence or machine learning (AI/ML) models. The customer-managed deployments can be configured to securely route queries for a chatbot or other AI-enabled system through the API gateway 113 and to the AI service 406, which can perform the processing (e.g., at the server system 110, at a third-party AI/ML service provider, or a combination of both) and provide generated responses back to the customer deployment.

The documentation 408 can describe pre-requisites and procedures for deployments and upgrades. For example, the documentation 408 can specify the capabilities needed (e.g., resources, services, etc.) for a cluster in order to deploy environments and applications.

The customer has responsibility for another set of items, especially related to the hardware and software infrastructure 430 used to run the cluster 122 in which the deployment tools from the application provider and deployed applications are run. For example, the customer-managed infrastructure 430 can include processors allocated (e.g., computation capability), memory, data storage, load balancing, file storage, networking interfaces, and so on. In addition, the customer has responsibility for application administration 410 to manage applications that have been deployed. In addition, the customer controls scaling 412 (e.g., increasing or decreasing the amount of memory and processing capability allocate), including meeting high availability (HA) and disaster recovery (DR) requirements if applicable. The customer applies its own customizations 414 and handles infrastructure upgrades 416. Customers also manage their infrastructure security and compliance 418 as well as continuous integration and continuous delivery (CI/CD) automation 420. Typical infrastructure management 422, such as day-to-day backups, monitoring, and logging are also handled by the customer.

The deployment model also includes areas of shared responsibility, where the application provider and the customer both contribute to the proper operation of the system. This includes areas such as management tools, such as the deployment infrastructure that resides in the customer's cluster, including the API gateway 134, management interface 133, cluster operator 136, deployment orchestrator 134 (if separate from the cluster operator 136), and so on. The software for these tools is provided by the application provider, and then installed into the customer's cluster where the customer will interact with them. The application provider remains responsible for providing updates to the management tools, which the customer will approve downloading and installing. Additional areas of shared responsibility include resource configuration 440, application updates 442, and application security patches 444. The application provider provides the container images 118 and other software for applications, which the customer runs. The application provider remains responsible for providing updates 442 and patches 444, which the customer then will need to approve and install. Similarly, although the customer has control over the cluster and infrastructure, the application may specify that certain resources or services are needed, and even with the customizations that a customer can provide, some resource configurations properties may be required for the applications to run properly.

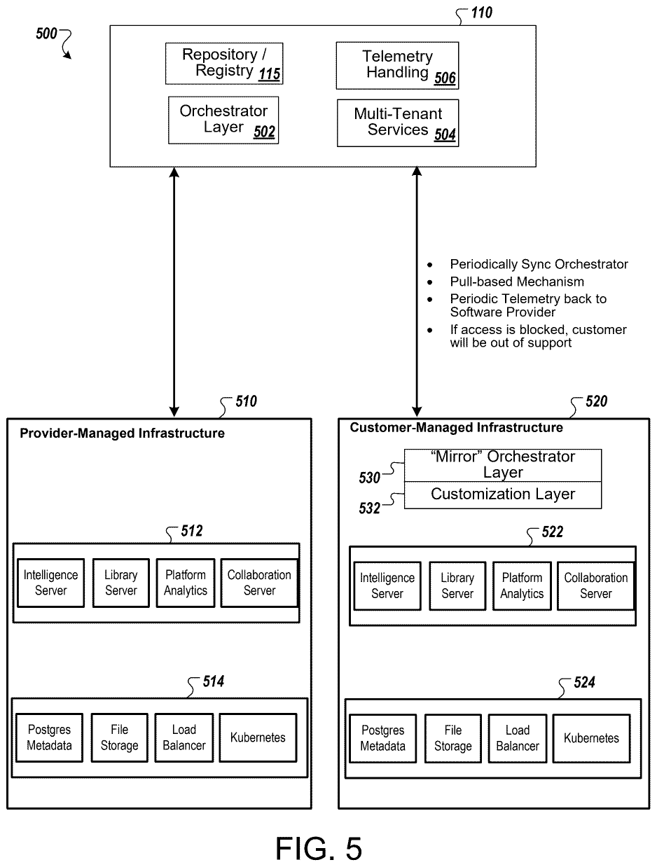

FIG. 5 is diagram showing an example of two different software deployments, one deployment 510 managed through a software provider's system and another deployment 520 managed by the customer using local management tools from the software provider.

The server system 110 includes a registry or repository 115 of software (e.g., container images 118, etc.) as discussed above. The server system 110 also includes an orchestrator layer 502 that includes tools for deploying and managing application-provider-managed deployments. The orchestrator layer 502 can include, for example, the API gateway 113, the management interface 114, the deployment orchestrator 112, and so on. The server system 110 also includes multi-tenant services 504, such as an API service 406 (see FIG. 4), a Python service or other processing services, search and indexing capablities, and so on. In addition, the server system 110 includes software for telemetry handling 506, for example, to receive and process incoming telemetry data from deployed environments and applications, and to generate output (e.g., recommendations, warnings, configuration changes, settings changes, etc.) to provide for the environments and applications in response.

The first deployment 510 is run on infrastructure managed by the application provider. This deployment 510 does not includes local management tools (e.g., no local API gateway or local management console is needed in the cluster), since the server system 110 provides these tools and management operations are performed by communication through the server system 110. The first deployment 510 includes an environment 512 with several applications. The environment runs on infrastructure 414 managed by the application provider, such as a metadata repository (e.g., Postgres metadata) file storage, a load balancer, a cluster operator, cluster management workflows, etc.). For the first deployment, the orchestrator layer 502 of the server system automatically performs the infrastructure deployment needed for the applications. The server system 110 provides end-to-end automation to deploy, upgrade, and scale the applications. This arrangement also provides access to the multi-tenant services 504, including AI/ML processing, data analysis, search and indexing, and so on. Management is performed by a centralized management interface (e.g., management interface 114 (FIG. 1) in the orchestrator layer 502).

The second deployment 520 is a customer-managed deployment. Although the applications and environments of the application provider do require certain resources, services, and configuration properties, the infrastructure to provide these needed items is provided by the customer. The deployment of the applications is decoupled from the deployment of the supporting infrastructure (e.g., cluster of processing nodes, load balancer, database services, etc.).

For the second deployment 520, there is an orchestrator layer 530 provided in the customer-managed cluster. This orchestrator layer 530 can be a “mirror” or analogous version to the server-based orchestrator layer 502. For example, the orchestrator layer 530 can include the API gateway 134, the management interface 133, the cluster operator 136, the deployment orchestrator 132, and so on. As a result, the customer's cluster includes the management tools, including those for supporting communication through the APIs and for deploying new environments and applications. The customer can create and manage the deployment of environments and applications through communication with the orchestrator layer 530 in the cluster, without communicating with the server system 110.

Using the orchestration layer 530, an environment 522 is created and various applications are deployed and run in it. The environment 522 and its applications, as well as the orchestrator layer 530, are supported by customer-provided and customer-managed infrastructure 524. The second deployment 520 also includes a customization layer 532 that the customer can use to store custom resources and apply customizations to the environment 522 and the applications that run in it. As discussed above, the customization layer 532 allows customers to customize deployments and ensure that the customizations will be retained even as software updates from the application provider are made. The custom resources are stored outside the environment 522, so that changes to the environment 522 or the applications in it do not affect the custom resources.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method performed by one or more computers, the method comprising:
obtaining, over a communication network, a set of software modules from a repository of a software provider;
based on the set of software modules, installing an application programming interface (API) gateway and a cluster operator module in a management namespace of a cluster or processing nodes;
using the cluster operator module to generate an environment namespace and install one or more applications in the environment namespace, wherein the one or more applications are obtained over the communication network from the repository of the software provider; and
maintaining a set of custom resources outside the environment namespace, wherein the custom resources provide customizations that are applied to the one or more applications in the environment namespace, and wherein software in the management namespace is configured to apply the customizations provided by the set of custom resources after software of the one or more applications in the environment namespace is updated.

2. The method of claim 1, wherein obtaining the set of software modules comprises obtaining one or more container images for the cluster operator module from the repository of the software provider; and
wherein the one or more applications are obtained in one or more container images from the repository of the software provider.

3. The method of claim 1, wherein the cluster is a Kubernetes cluster, and wherein the cluster operator is a custom Kubernetes operator.

4. The method of claim 1, wherein the cluster operator module is configured to obtain updates to the one or more applications from the software provider over the communication network, apply the updates to the one or more applications in the environment namespace, and apply the customizations from the set of custom resources to the one or more applications after applying the updates to the one or more applications.

5. The method of claim 1, wherein the set of custom resources is associated with the management namespace.

6. The method of claim 1, wherein the customizations comprise one or more of a change to a hostname, an update to a cluster management policy, or adding support for a third-party software agent.

7. The method of claim 1, comprising installing software in the management namespace that is configured to provide telemetry data to the software provider over the communication network, wherein the telemetry data comprises an amount of deployments or environments I the cluster, a software version for software in the cluster, license information for software in the cluster, usage data for software in the cluster, or status of services in the cluster.

8. The method of claim 1, wherein the API gateway is configured to enable an administrator to adjust a configuration of the cluster and the one or more applications through communication with the API gateway, including setting policies for data ingress and egress for the one or more applications.

9. The method of claim 1, wherein the API gateway implements in the cluster a same set of API gateway functions implemented by a server of the software provider for clusters managed through interaction with the server of the software provider, such that configuration changes made through API requests to the server of the software provider can be replicated through API requests to the API gateway.

10. A system comprising:
one or more computers; and
one or more computer-readable media storing instructions that are operable, when executed by the one or more computers, to cause the one or more computers to perform operations comprising:
obtaining, over a communication network, a set of software modules from a repository of a software provider;
based on the set of software modules, installing an application programming interface (API) gateway and a cluster operator module in a management namespace of a cluster of processing nodes;
using the cluster operator module to generate an environment namespace and install one or more applications in the environment namespace, wherein the one or more applications are obtained over the communication network from the repository of the software provider; and
maintaining a set of custom resources outside the environment namespace, wherein the custom resources provide customizations that are applied to the one or more applications in the environment namespace, and wherein software in the management namespace is configured to apply the customizations provided by the set of custom resources after software of the one or more applications in the environment namespace is updated.

11. The system of claim 10, wherein obtaining the set of software modules comprises obtaining one or more container images for the cluster operator module from the repository of the software provider; and
wherein the one or more applications are obtained in one or more container images from the repository of the software provider.

12. The system of claim 10, wherein the cluster is a Kubernetes cluster, and wherein the cluster operator is a custom Kubernetes operator.

13. The system of claim 10, wherein the cluster operator module is configured to obtain updates to the one or more applications from the software provider over the communication network, apply the updates to the one or more applications in the environment namespace, and apply the customizations from the set of custom resources to the one or more applications after applying the updates to the one or more applications.

14. The system of claim 10, wherein the set of custom resources is associated with the management namespace.

15. The system of claim 10, wherein the customizations comprise one or more of a change to a hostname, an update to a cluster management policy, or adding support for a third-party software agent.

16. The system of claim 10, comprising installing software in the management namespace that is configured to provide telemetry data to the software provider over the communication network, wherein the telemetry data comprises an amount of deployments or environments I the cluster, a software version for software in the cluster, license information for software in the cluster, usage data for software in the cluster, or status of services in the cluster.

17. The system of claim 10, wherein the API gateway is configured to enable an administrator to adjust a configuration of the cluster and the one or more applications through communication with the API gateway, including setting policies for data ingress and egress for the one or more applications.

18. The system of claim 10, wherein the API gateway implements in the cluster a same set of API gateway functions implemented by a server of the software provider for clusters managed through interaction with the server of the software provider, such that configuration changes made through API requests to the server of the software provider can be replicated through API requests to the API gateway.

19. One or more non-transitory computer-readable media storing instructions that are operable, when executed by one or more computers, to cause the one or more computers to perform operations comprising:
obtaining, over a communication network, a set of software modules from a repository of a software provider;
based on the set of software modules, installing an application programming interface (API) gateway and a cluster operator module in a management namespace of a cluster of processing nodes;
using the cluster operator module to generate an environment namespace and install one or more applications in the environment namespace, wherein the one or more applications are obtained over the communication network from the repository of the software provider; and
maintaining a set of custom resources outside the environment namespace, wherein the custom resources provide customizations that are applied to the one or more applications in the environment namespace, and wherein software in the management namespace is configured to apply the customizations provided by the set of custom resources after software of the one or more applications in the environment namespace is updated.

20. The one or more non-transitory computer-readable media of claim 19, wherein obtaining the set of software modules comprises obtaining one or more container images for the cluster operator module from the repository of the software provider; and
wherein the one or more applications are obtained in one or more container images from the repository of the software provider.
